(19) United States
(12) Patent Application Publication
(10) Pub. No.: US 2023/0275341 A1
(43) Pub. Date: Aug. 31, 2023

(54) ANTENNA STRUCTURE AND WEARABLE DEVICE HAVING SAME

(71) Applicant: Chiun Mai Communication Systems, Inc., New Taipei (TW)

(72) Inventors: CHO-KANG HSU, New Taipei (TW); YI-CHIEH LEE, New Taipei (TW); JUNG-CHIN LIN, New Taipei (TW); HSIN-SHENG HUANG, New Taipei (TW); CHANG-YI PENG, New Taipei (TW)

(21) Appl. No.: 18/113,005

(22) Filed: Feb. 22, 2023

Related U.S. Application Data
(60) Provisional application No. 63/315,064, filed on Feb. 28, 2022.

(51) Int. Cl. H01Q 1/27; H01Q 1/38; H04R 1/10

(52) U.S. Cl. CPC H01Q 1/273; H01Q 1/38; H04R 1/1041; H04R 1/1075; H04R 2420/07

(57) ABSTRACT

An antenna structure applied in a wearable device includes a first radiating portion, a ceramic layer, a plastic layer, and a feed portion. The first radiating portion is a metal structure. The ceramic layer covers and contacts the first radiating portion. The first radiating portion is arranged between the ceramic layer and the plastic layer. The feed portion passes through the plastic layer and feeds an electric current into the first radiating portion, the first radiating portion and the ceramic layer cooperatively generate radiation signals in at least one radiation frequency band. A wearable device having the antenna structure is also provided.

### CROSS-REFERENCE TO RELATED APPLICATIONS

This application claims priority to U.S. Patent provisional Application 63/315,064 filed on Feb. 28, 2022, the contents of which are incorporated by reference herein.

### FIELD

The subject matter herein generally relates to wireless communication technologies, and specially relates to an antenna structure and a wireless communication device having the antenna structure.

### BACKGROUND

With the advancement of wireless communication technology, wearable devices are now more multi-functional, smaller, lighter, faster transmitting, and higher efficiency. However, an antenna structure is complicated and occupies a large space in a wearable device, which makes miniaturization of the wearable device problematic. Sometimes it is needed to design metal logos arranged on a housing of the wearable device may affect a transmission characteristic of the antenna structure. Therefore, there is room for improvement within the art.

### BRIEF DESCRIPTION OF THE DRAWINGS

Implementations of the present disclosure will now be described, by way of example only, with reference to the attached figures.

FIG. 1 is a schematic diagram of a first embodiment of a wearable device including an antenna structure.

FIG. 2 is an explored diagram of the wearable device of FIG. 1 including the antenna structure.

FIG. 3 is another explored diagram of the wearable device of FIG. 1 including the antenna structure.

FIG. 4 is a cross-sectional view of the first embodiment of the wearable device of FIG. 1 including the antenna structure.

FIG. 5 is a return loss graph of the antenna structure of FIG. 1 applied in the wearable device.

FIG. 6 is a radiation efficiency graph of the antenna structure of FIG. 1 applied in the wearable device.

FIG. 7 is a schematic diagram of a second embodiment of a wearable device including an antenna structure.

FIG. 8 is an explored diagram of the second embodiment of the wearable device of FIG. 7 including the antenna structure with a non-metal pattern structure.

FIG. 9 is an explored diagram of the second embodiment of the wearable device of FIG. 7 including the antenna structure with a metal pattern structure.

FIG. 10 is a cross-sectional view of the wearable device of FIG. 7 including the antenna structure.

FIG. 11 is a return loss graph of the antenna structure of FIG. 8 arranging a non-metal pattern structure applied in the wearable device.

FIG. 12 is a radiation efficiency graph of the antenna structure of FIG. 8 arranging the non-metal pattern structure applied in the wearable device.

FIG. 13 is a return loss graph of the antenna structure of FIG. 9 arranging a metal pattern structure applied in the wearable device.

FIG. 14 is a radiation efficiency graph of the antenna structure of FIG. 9 arranging the metal pattern structure applied in the wearable device.

FIG. 15 is a return loss graph of the antenna structure of FIG. 8 arranging a non-metal pattern structure and a ceramic layer with predetermined dielectric constants applied in the wearable device.

FIG. 16 is a radiation efficiency graph of the antenna structure of FIG. 8 arranging the non-metal pattern structure and the ceramic layer with predetermined dielectric constants applied in the wearable device.

FIG. 17 is a return loss comparison graph of the antenna structure of FIG. 7 arranging a non-metal pattern structure and a metal pattern structure applied in the wearable device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The present disclosure is described in relation to an antenna structure and a wearable device having the same.

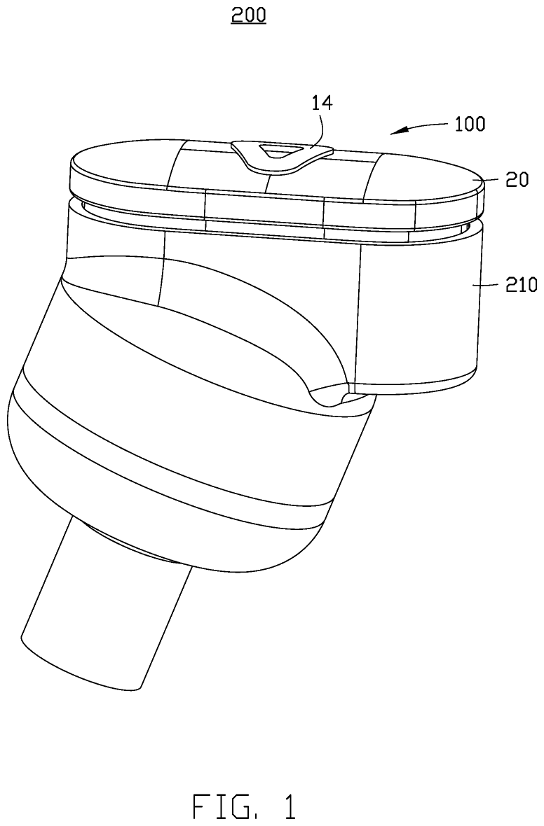

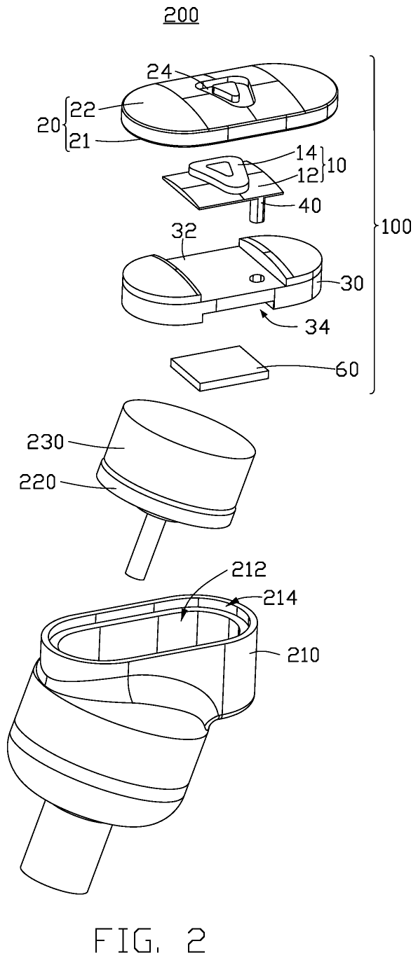

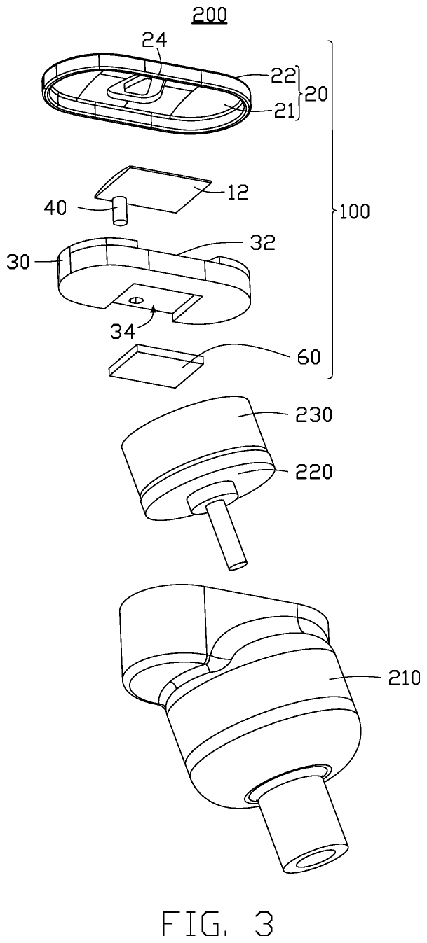

FIG. 1 to FIG. 4 illustrate a first embodiment of a wearable device 200 having an antenna structure 100. The antenna structure 100 may be applied in the wearable device 200, which may be for example, a headset, a headphone, an earphone, or a head-mounted telephone receiver. The antenna structure 100 may transmit and receive radio waves, to exchange wireless signals.

The wearable device 200 may be used in any of the following communication technologies: BLUETOOTH (BT) communication technology, global positioning system (GPS) communication technology, wireless fidelity (Wi-Fi) communication technology, global system for mobile communication (GSM) technology, wideband code division multiple access (WCDMA) communication technology, long term evolution (LTE) communication technology, 5G communication technology, SUB-6G communication technology, and any other future communication technologies.

Referring to FIGS. 1, 2, 3, and 4, the wearable device 200 includes the antenna structure 100, a housing 210, a speaker 220, and a battery 230. The antenna structure 100, the speaker 220, and the battery 230 may be received in the housing 210.

The housing 210 is substantially hollow to form a receiving chamber 212. The housing 210 forms an opening 214 to connect the receiving chamber 212 and external of the housing 210. In at least one embodiment, an area of the opening 214 is greater than a cross-sectional opening area of the receiving chamber 212, so a peripheral wall of the opening 214 and a peripheral wall of the receiving chamber 212 may cooperatively form a stepped structure, a top surface of the peripheral wall of the receiving chamber 212 may form a supporting surface.

The antenna structure 100, the speaker 220, and the battery 230 may be orderly received in the receiving chamber 212. In at least one embodiment, the housing 210 may be made of plastic materials. It should be known that, according to appearance demands of the wearable device 200, the housing 210 may be made of other non-metal materials, such as glass, wood, ceramic, etc.

The antenna structure 100 includes a first radiating portion 10, a ceramic layer 20, a plastic layer 30, a feed portion 40, and a circuit board 60.

The first radiating portion 10 may be a metal structure and configured to radiate wireless signals. The first radiating portion 10 may include a metal plate 12 and a protruding portion 14. The metal plate 12 is substantially a planar structure or a curve planar structure. The protruding portion 14 is substantially protruded from a central portion of the metal plate 12 and protruding to exterior of the wearable device 200. The protruding portion 14 may be a predetermined metal pattern structure. In at least one embodiment, the metal plate 12 and the protruding portion 14 may be a metal structure formed by integrated molding. In at least one embodiment, the protruding portion 14 is substantially an English letter A-shaped and has bent extended radiating arms, the radiating arms may form corresponding radiation paths. In another embodiment, the protruding portion 14 may be other three-dimensional pattern structure, such as circular, square, semicircular, font shape, pattern shape, spherical, etc., which may form corresponding radiation paths.

The ceramic layer 20 may be mounted to the opening 214 of the housing 210, to close the receiving chamber 212. The ceramic layer 20 includes an internal surface 21 and an external surface 22 corresponding to each other. The external surface 22 may be an appearance surface of the wearable device 200, that is, the external surface 22 may be an exterior surface of the wearable device 200, the internal surface 21 may be an interior surface of the wearable device 200 facing the receiving chamber 212. The ceramic layer 20 may define a hole 24. In at least one embodiment, the hole 24 is defined throughout the ceramic layer 20, that is, the hole 24 is defined from the internal surface 21 to the external surface 22, the hole 24 is exposed from the external surface 22.

The ceramic layer 20 may cover and contact the first radiating portion 10. In at least one embodiment, the internal surface 21 of the ceramic layer 20 contacts the metal plate 12. The protruding portion 14 is inserted in the hole 24 and extended to coplanar with the external surface 22, the protruding portion 14 is exposed from the external surface 22. Thus, the protruding portion 14 being the predetermined metal pattern structure is exposed from the appearance surface of the wearable device 200, to form a predetermined metal logo. It should be known that, the protruding portion 14 may be metal logos in other structures according to design demands, and exposed from the appearance surface of the wearable device 200, to form characteristic metal logos, so as to improve a peculiarity and an identifiability of the wearable device 200. In at least one embodiment, a shape and a size of the protruding portion 14 are corresponding to a shape and a size of the hole 24, so being observed from the appearance surface of the wearable device 200, only the protruding portion 14 can be seen, other parts of the ceramic layer 20 may not be seen, so as to improve an aesthetic of the metal logo formed by the protruding portion 14.

The ceramic layer 20 may be made of ceramic materials with predetermined dielectric constants. In at least one embodiment, a range of the predetermined dielectric constants of the ceramic layer 20 may be 2˜100. The ceramic layer 20 is non-metal, but has the range of the predetermined dielectric constants, which may efficiently improve the antenna radiation. Thus, the ceramic layer 20 may form a ceramic antenna.

The plastic layer 30 may be mounted to the opening 214 of the housing 210 and on the top surface of the peripheral wall of the receiving chamber 212. A cross-sectional area of the plastic layer 30 may be corresponding to an area of the opening 210, so the opening may be filled with the plastic layer 30.

The plastic layer 30 may define a first slot 32. In at least one embodiment, the first slot 32 is formed by recessing from a surface of the plastic layer 30 facing the ceramic layer 20. A structure of the first slot 32 may be corresponding to the first radiating portion 10, the first radiating portion 10 is arranged in the first slot 32 and coplanar with a surface of the plastic layer 30. The ceramic layer 20 covers the plastic layer 30 and the first radiating portion 10, the plastic layer 30 contacts the internal surface 21 of the ceramic layer 20. In other embodiments, the plastic layer 30 may be made of other non-conductive materials, not limited by the plastic materials of the present disclosure. The plastic layer 30 may further define a second slot 34. In at least one embodiment, the second slot 34 is formed by recessing from a surface of the plastic layer 30 facing the circuit board 60. A structure of the second slot 34 may be corresponding to the circuit board 60, the circuit board 60 is arranged in the second slot 34 and coplanar with a surface of the plastic layer 30.

The feed portion 40 may be electrically connected between the first radiating portion 10 and the circuit board 60. The feed portion 40 may be made of metal conductive materials and configured to feed an electric current from the circuit board 60 into the first radiating portion 10. One end of the feed portion 40 may insert through the plastic layer 30 and extend to the first slot 32 to electrically connect to the first radiating portion 10. Another end of the feed portion 40 may be electrically connected to a feeding source or a feeding point on the circuit board 60 for feeding the electric current. In at least one embodiment, the feed portion 40 may be but is not limited to a metal piece, an elastic sheet, a microstrip line, a strip line, or a coaxial cable, etc.

The circuit board 60 is arranged apart from a side of the plastic layer 30 that away from the ceramic layer 20, the circuit board 60 is received in the second slot 34. The circuit board 60 further provides ground for the first radiating portion 10.

In at least one embodiment, the antenna structure 100 may further include a matching circuit (not shown in the figures). The matching circuit may be arranged on the circuit board 60 and electrically connected to the feed portion 40, for adjusting a radiation frequency band of the radiation signals generated by the first radiating portion 10 and the ceramic layer 20, the matching circuit may adjust the radiation frequency band offset, so as to adjust a working mode of the antenna structure 100 to working frequency band to obtain a great radiation efficiency by the matching circuit. In at least one embodiment, the matching circuit may be arranged to different positions according to actual design demands of the product. In a first embodiment, the matching circuit may be arranged on a surface of the plastic layer 30 facing the ceramic layer 20. The main circuit of the circuit board 60 outputs signals through the feed portion 40 and then the matching circuit, and final conducting to the first radiating portion 10 by the feed portion 40. In a second embodiment, the matching circuit may be arranged on a surface of the plastic layer 30 facing the circuit board 60, signals outputted by the main circuit of the circuit board 60 may be conducted through the matching circuit, and further conducted to the first radiating portion 10 by the feed portion 40. In a third embodiment, the matching circuit may be arranged on the circuit board 60, signals outputted by the main circuit of the circuit board 60 may be conducted through the matching circuit, and further conducted to the first radiating portion 10 by the feed portion 40. The matching circuit may be electrically connected to the feed portion 40 and configured to adjust a radiation frequency band of the radiation signals generated by the first radiating portion 10.

The speaker 220 and the battery 230 may be arranged on a side of the circuit board 60 away from the plastic layer 30, to decrease affection to the radiation signals generated by the first radiating portion 10 and the ceramic layer 20. In another embodiment, the speaker 220, the battery 230, and the circuit board 60 may be arranged on a same side of the plastic layer 30, an isolation layer may be arranged therebetween, to decrease affection to the radiation signals generated by the first radiating portion 10 and the ceramic layer 20.

In at least one embodiment, when the first radiating portion 10 supplies the electric current through the feed portion 40, the electric current flows through the first radiating portion 10, then the electric current is further conducted to and radiated in the metal plate 12 and the protruding portion 14, the metal plate 12 contacts the ceramic layer 20, the first radiating portion 10 and the ceramic layer 20 cooperatively form an antenna resonate radiating structure, and adjusted by the matching circuit, to excite a first working mode and generate a radiation signal in a first radiation frequency band, and to excite a second working mode and generate a radiation signal in a second radiation frequency band. In at least one embodiment, the first working mode includes a Bluetooth and WiFi 2.4 GHz mode, the frequency of the first radiation frequency band includes 2400-2484 MHz; the second working mode includes a WiFi 5 GHz mode, the frequency of the second radiation frequency band includes 5150-5850 MHz.

In at least one embodiment, the first radiating portion 10 feeds in the electric current through the feed portion 40, the first radiating portion 10 and the ceramic layer 20 cooperatively form a monopole antenna radiating portion.

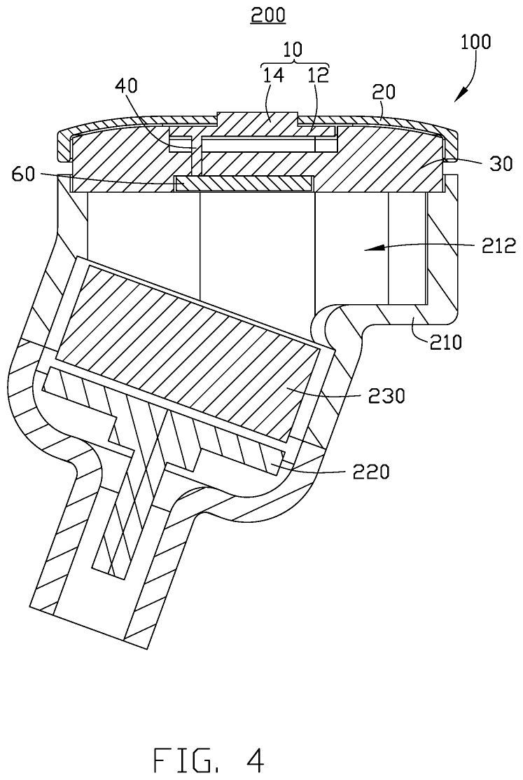

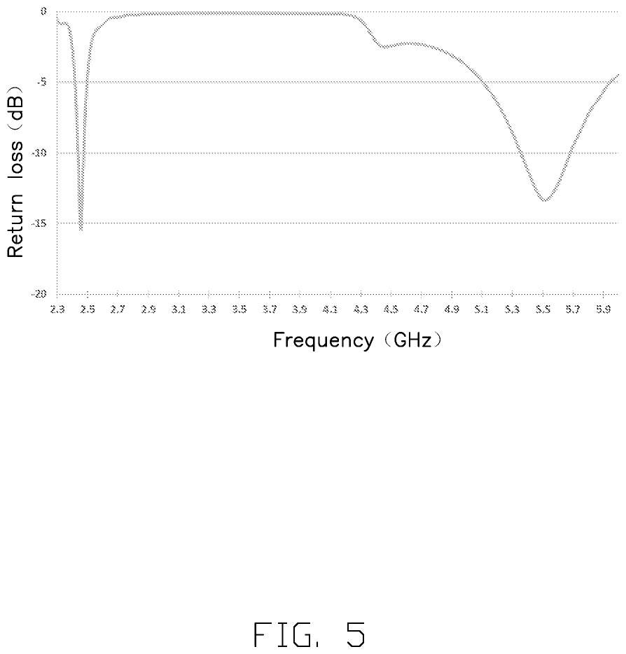

FIG. 5 is a return loss graph of the antenna structure 100 of FIG. 4 in operation. The curve shown in FIG. 5 shows return loss values of the antenna structure 100 applied in the wearable device 200. Known from FIG. 5, the antenna structure 100 may efficiently improve the working frequency band width in the first radiation frequency band (2400-2484 MHz) and the second radiation frequency band (5150-5850 MHz), and has a great radiation frequency band.

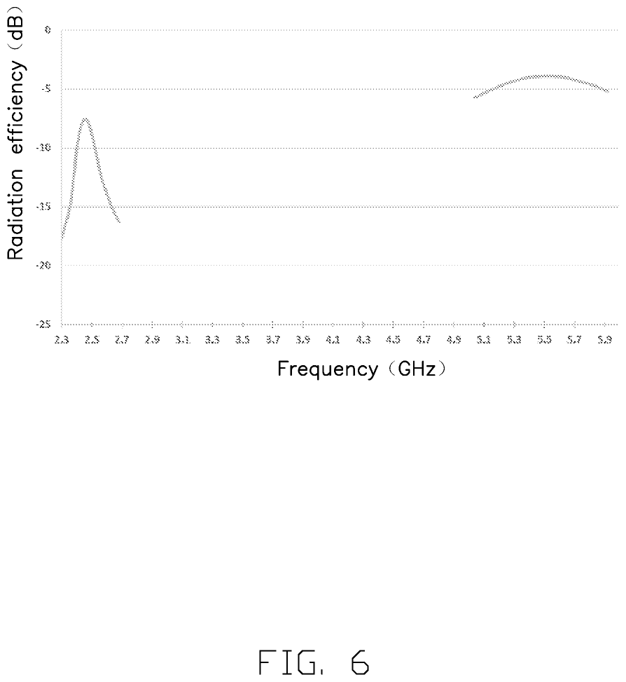

FIG. 6 is a radiation efficiency graph of the antenna structure 100 of FIG. 4 in operation. The curve shown in FIG. 6 shows radiation efficiencies of the antenna structure 100 applied in the wearable device 200, which shows the antenna structure 100 has a good radiation characteristic in the designed frequency band.

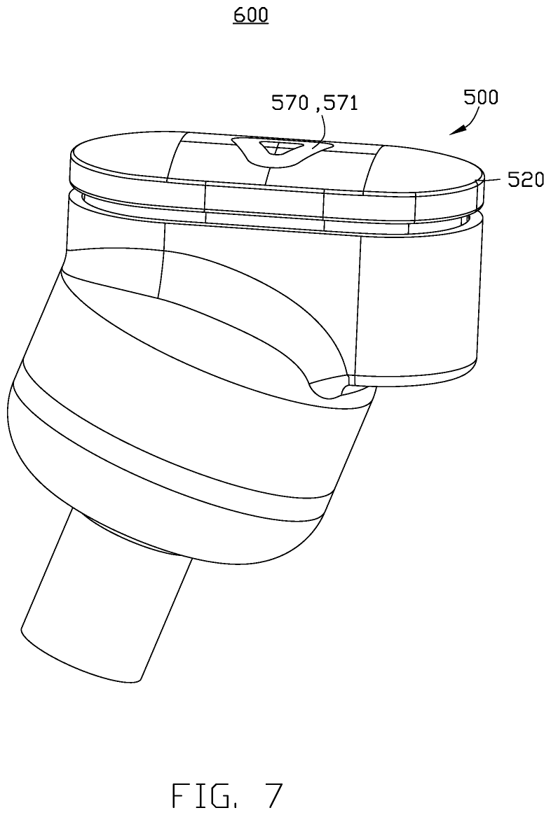

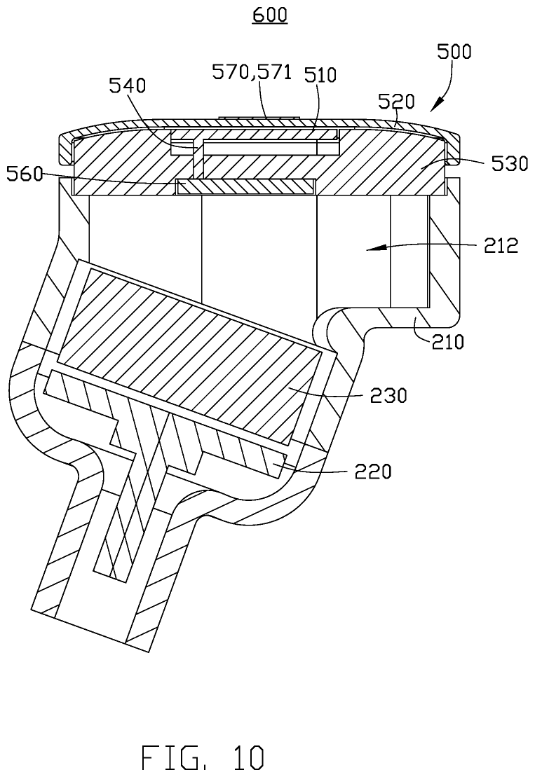

FIGS. 7 to 10 illustrate a second embodiment of a wearable device 600 having an antenna structure 500. The antenna structure 500 may be applied in the wearable device 600, which may be, for example, a headset, a headphone, an earphone, or a head-mounted telephone receiver. The antenna structure 500 may transmit and receive radio waves to exchange wireless signals. The wearable device 600 of the second embodiment is similar to the wearable device 200 of the first embodiment; merely parts of elements of the antenna structure 500 of the second embodiment are different from those of the antenna structure 100 of the first embodiment.

In details, the antenna structure 500 includes a first radiating portion 510, a ceramic layer 520, a plastic layer 530, a feed portion 540, a circuit board 560, and a pattern structure 570, 571. The plastic layer 530, the feed portion 540, and the circuit board 560 are similar to the plastic layer 30, the feed portion 40, and the circuit board 60 of the first embodiment, which are no longer repeated.

The first radiating portion 510 is a metal structure and substantially a planar structure or a curved planar structure. The first radiating portion 510 is configured to radiate wireless signals. The first radiating portion 510 may be arranged in the first slot 532 of the plastic layer 530 and coplanar with a surface of the plastic layer 530.

The ceramic layer 520 may cover the plastic layer 530 and the first radiating portion 510, the ceramic layer 520 contacts the first radiating portion 510. The first radiating portion 510 is covered between the ceramic layer 520 and the plastic layer 530. The ceramic layer 520 compares to the ceramic layer 20 of the first embodiment, the ceramic layer 520 does not define the hole 24, the first radiating portion 510 is not exposed from the appearance surface of the wearable device 600.

The ceramic layer 520 may be made of ceramic materials with predetermined dielectric constants. In at least one embodiment, a range of the predetermined dielectric constants of the ceramic layer 520 may be 2˜100. Thus, the ceramic layer 520 may couple from the first radiating portion 510 to form a ceramic antenna.

The pattern structure 570, 571 may be a predetermined pattern. The pattern structure 570, 571 may be formed on the external surface 522 of the ceramic layer 520 by surface coating or air spraying. In at least one embodiment, the pattern structure 570, 571 may be made of metal materials or non-metal materials, the surface coating or air spraying may be Physical Vapor Deposition (PVD). Thus, the pattern structure 570, 571 may be exposed from the appearance surface of the wearable device 600, to form a predetermined logo. It should be known that, the pattern structure 570, 571 may be logos in other structures according to design demands, and exposed from the appearance surface of the wearable device 600, to form characteristic logos, so as to improve a peculiarity and an identifiability of the wearable device 600.

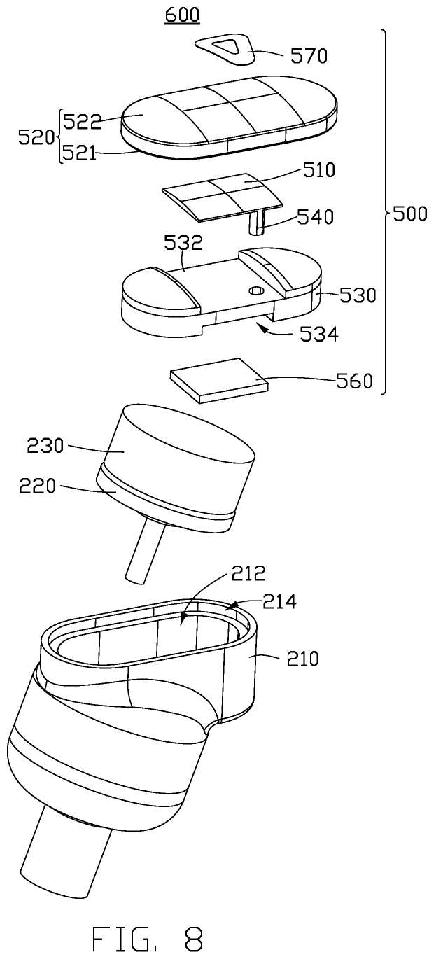

Referring to FIG. 8, in at least one embodiment, when the feed portion 540 supplies the electric current from the circuit board 560, the electric current flows through the first radiating portion 510, the first radiating portion 510 and the ceramic layer 520 cooperatively form an antenna resonating structure, to excite a third working mode and generate a radiation signal in a third radiation frequency band, and to excite a fourth working mode and generate a radiation signal in a fourth radiation frequency band. In at least one embodiment, the third working mode includes a Bluetooth and a WiFi 2.4 GHz mode, the frequency of the third radiation frequency band includes 2400-2484 MHz; the fourth working mode includes a WiFi 5 GHz mode, the frequency of the fourth radiation frequency band includes 5150-5850 MHz.

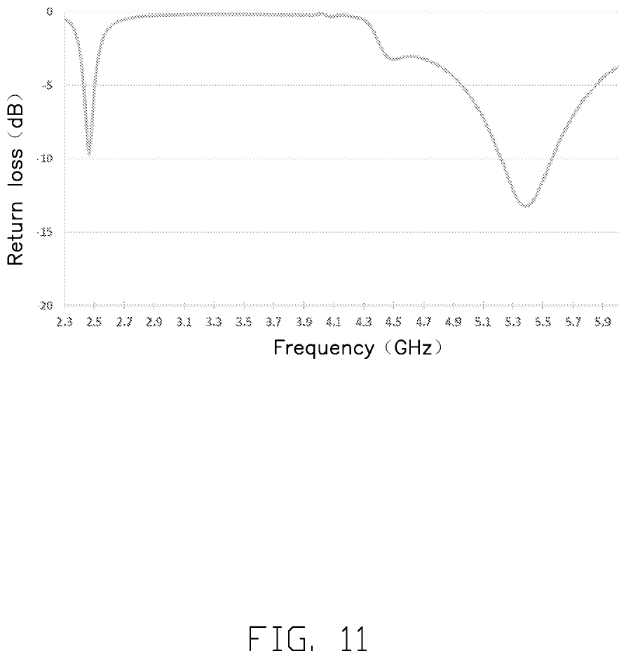

FIG. 11 is a return loss graph of the antenna structure 500 arranging the pattern structure 570 with non-metal materials in operation. The curve shown in FIG. 11 shows return loss values of the antenna structure 500 coating or spraying with the pattern structure 570 with non-metal materials in operation.

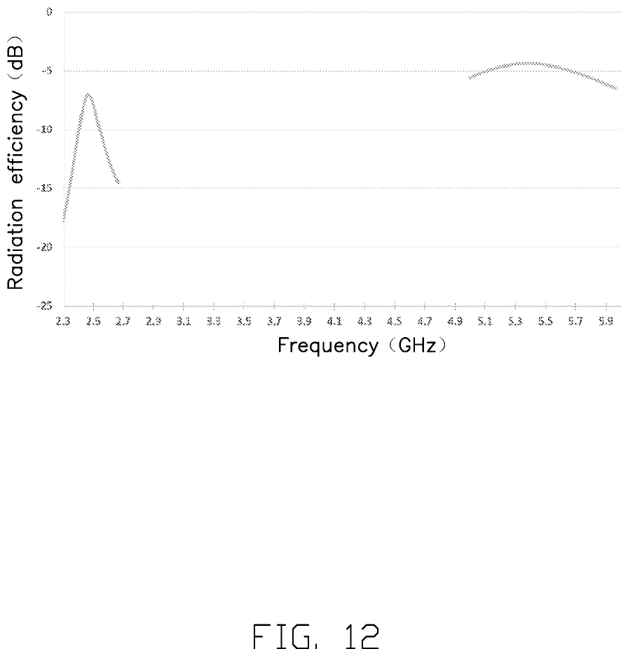

FIG. 12 is a radiation efficiency graph of the antenna structure 500 arranging the pattern structure 570 with non-metal materials in operation. The curve shown in FIG. 12 shows the radiation efficiency of the antenna structure 500 coating or spraying with the pattern structure 570 with non-metal materials in operation, known from FIG. 12, the antenna structure 500 has a good radiation characteristic in the desired radiation frequency band.

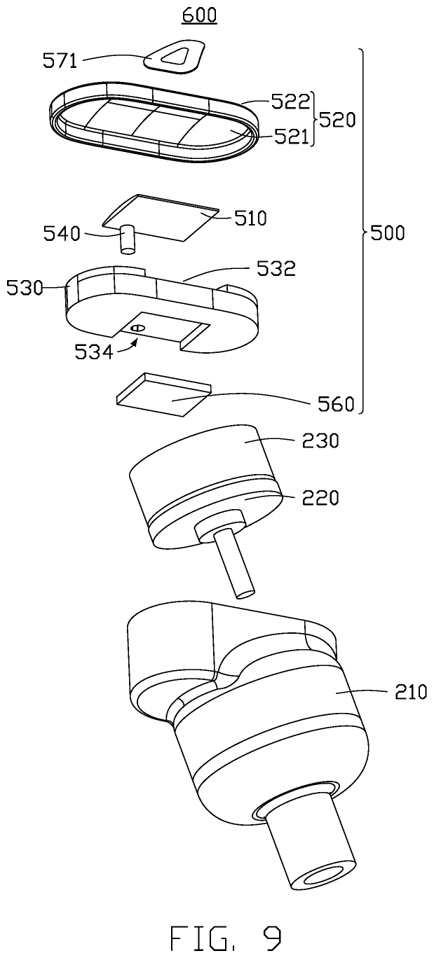

Referring to FIG. 9, in at least one embodiment, when the feed portion 540 supplies the electric current from the circuit board 560, the electric current flows through the first radiating portion 510, then the electric current is further coupled to the pattern structure 571 being metal materials arranged on the ceramic layer 520, the first radiating portion 510, the ceramic layer 520, and the pattern structure 571 cooperatively form an antenna resonating structure, to excite a fifth working mode and generate a radiation signal in a fifth radiation frequency band, and to excite a sixth working mode and generate a radiation signal in a sixth radiation frequency band. In at least one embodiment, the fifth working mode includes a Bluetooth and a WiFi 2.4 GHz mode, the frequency of the fifth radiation frequency band includes 2400-2484 MHz; the sixth working mode includes a WiFi 5 GHz mode, the frequency of the sixth radiation frequency band includes 5150-5850 MHz.

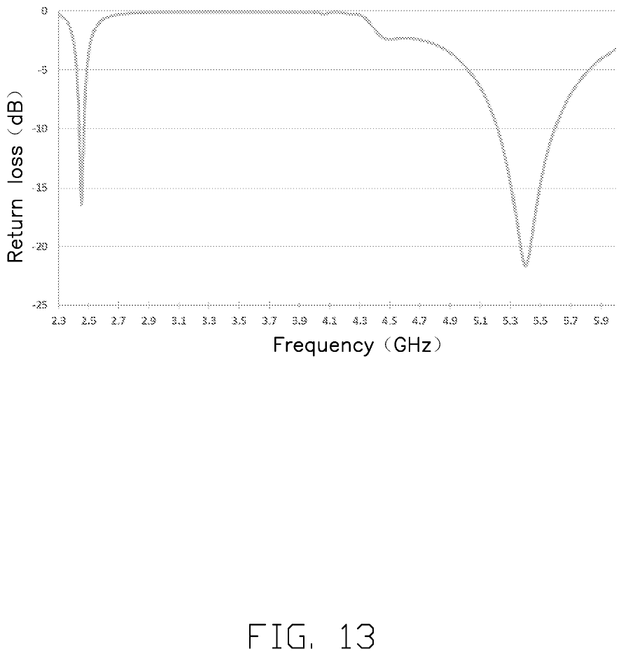

FIG. 13 is a return loss graph of the antenna structure 500 arranging the pattern structure 571 with metal materials in operation. The curve shown in FIG. 13 shows return loss values of the antenna structure 500 coating or spraying with the pattern structure 571 with metal materials in operation. It should be known that, the antenna structure 500 may efficiently improve the working frequency band width in the fifth radiation frequency band (2400-2484 MHz) and the sixth radiation frequency band (5150-5850 MHz), and has a great radiation frequency band.

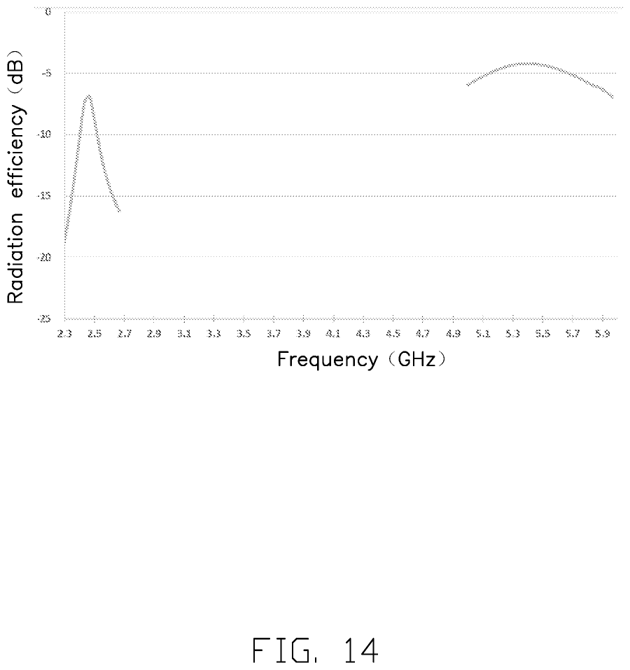

FIG. 14 is a radiation efficiency graph of the antenna structure 500 arranging the pattern structure 571 with metal materials in operation. The curve shown in FIG. 13 shows a radiation efficiency of the antenna structure 500 coating or spraying with the pattern structure 571 with metal materials in operation, known from FIG. 14, the antenna structure 500 has a good radiation characteristic in the desired radiation frequency band.

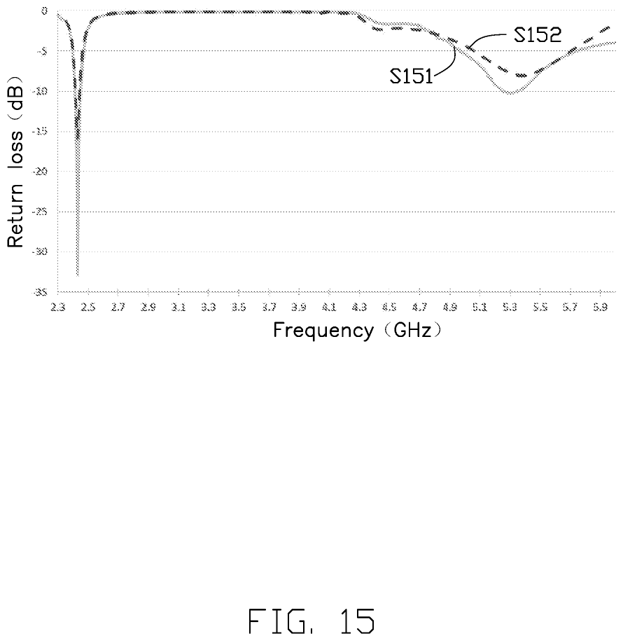

FIG. 15 is a return loss graph of the antenna structure 500 arranging the pattern structure 570 with non-metal materials and the ceramic layer 520 with the predetermined dielectric constants in operation. A curve S151 shows return loss values of the antenna structure 500 coating or spraying with the pattern structure 570 with non-metal materials and the ceramic layer 520 with a predetermined dielectric constant of 2 in operation. A curve S152 shows return loss values of the antenna structure 500 coating or spraying with the pattern structure 570 with non-metal materials and the ceramic layer 520 with a predetermined dielectric constant of 100 in operation. It should be known that, the antenna structure 500 may efficiently improve the working frequency band width in the third radiation frequency band (2400-2484 MHz) and the fourth radiation frequency band (5150-5850 MHz), and has a great radiation frequency band.

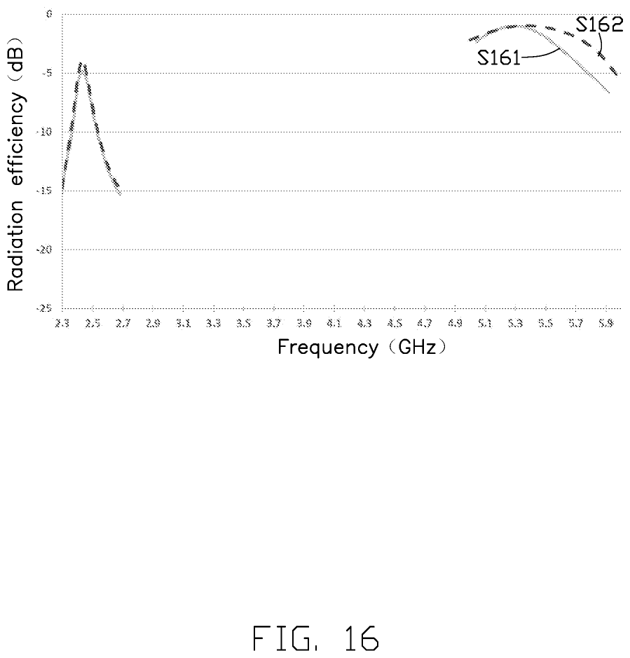

FIG. 16 is a radiation efficiency graph of the antenna structure 500 arranging the pattern structure 570 with non-metal materials and the ceramic layer 520 with the predetermined dielectric constants in operation. A curve S161 shows a radiation efficiency of the antenna structure 500 coating or spraying with the pattern structure 570 with non-metal materials and the ceramic layer 520 with a predetermined dielectric constant of 2 in operation. A curve S162 shows a radiation efficiency of the antenna structure 500 coating or spraying with the pattern structure 570 with non-metal materials and the ceramic layer 520 with a predetermined dielectric constant of 100 in operation. Known from FIG. 16, the antenna structure 500 has a good radiation characteristic in the desired radiation frequency band.

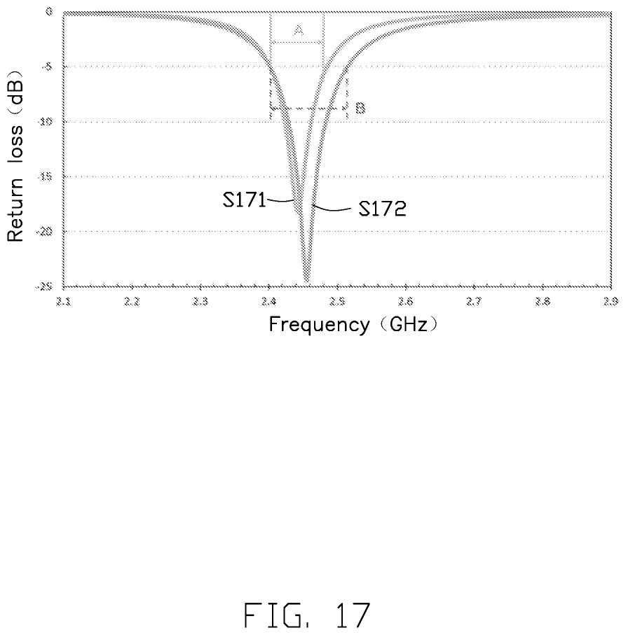

FIG. 17 is a return loss comparison graph of the antenna structure 500 arranging the pattern structure 570 with non-metal materials and the pattern structure 571 with metal materials in operation. A curve S171 shows return loss values of the antenna structure 500 using the pattern structure 570 with non-metal materials in operation; a curve S172 shows return loss values of the antenna structure 500 using the pattern structure 571 with metal materials in operation. Regarding to a return loss value of −6 dB, a mark A in FIG. 17 shows return loss values of the antenna structure 500 using the pattern structure 570 with non-metal materials in operation, a frequency bandwidth may be from 2.4 GHz to 2.48 GHz; a mark B in FIG. 17 shows return loss values of the antenna structure 500 using the pattern structure 571 with metal materials in operation, a frequency bandwidth may be from 2.4 GHz to 2.52 GHz, the metal logo and the antenna coupling may achieve a great antenna frequency bandwidth.

The antenna structure 100, 500 sets the protruding portion 14 or the pattern structure 570, 571 exposed from the appearance surface of the wearable device 200, 600 to form the predetermined logo, which may improve a peculiarity and an identifiability of the wearable device 200, 600. Meanwhile, the antenna structure 100, 500 sets the ceramic layer 20, 520 couples the electric current from the first radiating portion 10, 510 having the predetermined dielectric constants, to achieve the working frequency band of the antenna structure 100, 500 and cover the frequency band of the Bluetooth and WiFi 2.4 GHz mode and WiFi 5 GHz mode, which may improve frequency width of the antenna structure 100, 500 and radiation efficiency of the antenna structure 100, 500, achieving a great transmission characteristic of the wearable device 200, 600.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna structure applied in a wearable device, the antenna structure comprising:
a first radiating portion, the first radiating portion being a metal structure;
a ceramic layer, the ceramic layer covering and contacting the first radiating portion;
a plastic layer, the first radiating portion arranged between the ceramic layer and the plastic layer; and
a feed portion, the feed portion passing through the plastic layer and feeding an electric current into the first radiating portion, the first radiating portion and the ceramic layer cooperatively generating radiation signals in at least one radiation frequency band.

2. The antenna structure of claim 1, wherein the ceramic layer is arranged on an external surface of the wearable device, the ceramic layer covers the first radiating portion and the plastic layer.

3. The antenna structure of claim 1, wherein the first radiating portion comprises a metal plate, the metal plate is received in the plastic layer and paralleled with the ceramic layer.

4. The antenna structure of claim 3, wherein the first radiating portion further comprises a protruding portion, the protruding portion is protruded from the metal plate, the protruding portion is a predetermined metal pattern structure.

5. The antenna structure of claim 4, wherein the ceramic layer defines a hole, the protruding portion is inserted through the hole and exposed from an external surface of the ceramic layer.

6. The antenna structure of claim 1, wherein the ceramic layer comprises an internal surface and an external surface corresponding to each other, the internal surface of the ceramic layer faces and covers the first radiating portion, the external surface of the ceramic layer arranges a pattern structure.

7. The antenna structure of claim 6, wherein the external surface of the ceramic layer arranges the pattern structure with metal materials.

8. The antenna structure of claim 6, wherein the external surface of the ceramic layer arranges the pattern structure with non-metal materials.

9. The antenna structure of claim 1, wherein a surface of the ceramic layer is coated or sprayed with a predetermined metal pattern structure.

10. The antenna structure of claim 1, further comprising a circuit board, wherein the plastic layer defines a first slot and a second slot, the first slot faces the ceramic layer, the second slot faces the circuit board, the first radiating portion is received in the first slot, the circuit board is received in the second slot.

11. A wearable device, comprising:
a housing; and
an antenna structure received in the housing, the antenna structure comprising:
a first radiating portion, the first radiating portion being a metal structure;
a ceramic layer, the ceramic layer covering and contacting the first radiating portion;
a plastic layer, the first radiating portion arranged between the ceramic layer and the plastic layer; and
a feed portion, the feed portion passing through the plastic layer and feeding an electric current into the first radiating portion, the first radiating portion and the ceramic layer cooperatively generating radiation signals in at least one radiation frequency band.

12. The wearable device of claim 11, wherein the ceramic layer is arranged on an external surface of the wearable device, the ceramic layer covers the first radiating portion and the plastic layer.

13. The wearable device of claim 11, wherein the first radiating portion comprises a metal plate, the metal plate is received in the plastic layer and paralleled with the ceramic layer.

14. The wearable device of claim 13, wherein the first radiating portion further comprises a protruding portion, the protruding portion is protruded from the metal plate, the protruding portion is a predetermined metal pattern structure.

15. The wearable device of claim 14, wherein the ceramic layer defines a hole, the protruding portion is inserted through the hole and exposed from an external surface of the ceramic layer.

16. The wearable device of claim 11, wherein the ceramic layer comprises an internal surface and an external surface corresponding to each other, the internal surface of the ceramic layer faces and covers the first radiating portion, the external surface of the ceramic layer arranges a pattern structure.

17. The wearable device of claim 16, wherein the external surface of the ceramic layer arranges the pattern structure with metal materials.

18. The wearable device of claim 16, wherein the external surface of the ceramic layer arranges the pattern structure with non-metal materials.

19. The wearable device of claim 11, wherein a surface of the ceramic layer is coated or sprayed with a predetermined metal pattern structure.

20. The wearable device of claim 11, wherein the antenna structure further comprises a circuit board, wherein the plastic layer defines a first slot and a second slot, the first slot faces the ceramic layer, the second slot faces the circuit board, the first radiating portion is received in the first slot, the circuit board is received in the second slot.
